(19) United States
(12) Patent Application Publication
(10) Pub. No.: US 2017/0175614 A1
(43) Pub. Date: Jun. 22, 2017

(54) GASOLINE COMPRESSION IGNITION (GCI) ENGINE WITH DEDICATED-EGR CYLINDERS

(71) Applicant: Cummins Inc., Columbus, IN (US)

(72) Inventors: Steven J. Kolhouse, Columbus, IN (US); Lyle E. Kocher, Whiteland, IN (US); Samuel C. Geckler, Columbus, IN (US)

(21) Appl. No.: 15/385,516

(22) Filed: Dec. 20, 2016

Related U.S. Application Data
(60) Provisional application No. 62/270,473, filed on Dec. 21, 2015.

(51) Int. Cl. F02B 7/08; F02D 41/00; F02M 26/43; F02P 9/00

(52) U.S. Cl. CPC F02B 7/08; F02P 9/002; F02D 41/0052; F02M 26/43

(57) ABSTRACT

The present disclosure provides a method comprising adjusting at least one of an air-to-fuel ratio and an ignition spark characteristic of a first cylinder of an engine to produce an exhaust gas comprising a predetermined quantity of hydrogen; and providing the exhaust gas from the first cylinder to a second cylinder of the engine, wherein the exhaust gas comprising the hydrogen ignites a first fuel type in response to a compression event.

### CROSS-REFERENCE TO RELATED APPLICATIONS

This application claims the benefit under 35 U.S.C. §119(e) of U.S. Provisional Patent Application Ser. No. 62/270,473, filed Dec. 21, 2015, the disclosure of which is hereby incorporated by reference in its entirety.

### FIELD OF THE DISCLOSURE

The present disclosure generally relates to internal combustion engines with dedicated-exhaust gas recirculation (“EGR”) cylinders, and more specifically to gasoline compression ignition engines having one or more cylinders that are dedicated to providing exhaust gas for recirculation to the intake manifold of the internal combustion engine.

### BACKGROUND OF THE DISCLOSURE

Diesel engines are generally regarded as having prodigious torque and impressive fuel economy, however the diesel fuel supplied to these engines has several drawbacks. Diesel fuel is often times more expensive than alternative fuels such as gasoline and ethanol based fuels. Moreover, while diesel fuel contains roughly 15% more potential energy than gasoline volumetrically, the inherent properties of diesel fuel also present unique challenges to manage pollutant formation and control. Typically, further injection, combustion and subsequent burning of diesel fuel for engine operation requires the use of costly engine components, such as high-pressure fuel pumps, particulate filters, and urea-injection systems including complex high-pressure fuel injectors. As an alternative to diesel engines, gasoline compression ignition engines could offer diesel like performance if further advances are provided with regard to, for example, controlled ignition of gasoline injected into one or more cylinders during low engine load operating conditions. Engines operating with one or more cylinders as dedicated EGR cylinders enjoy greatly simplified controls and pressure management, fewer hardware devices, and other benefits. Additionally, a gasoline compression ignition engine having at least one dedicated EGR cylinder provides an opportunity for greater control over the temperature and composition of gases at the intake manifold, if a system could be developed to take advantage of this opportunity. Therefore, further technological developments are desirable in this area.

### SUMMARY OF THE DISCLOSURE

In one embodiment of the present disclosure, a method is provided comprising: adjusting at least one of an air-to-fuel ratio supplied to a first cylinder and an ignition spark characteristic of the first cylinder of an engine to produce an exhaust gas comprising a quantity of hydrogen; and providing the exhaust gas from the first cylinder to a second cylinder of the engine, wherein the exhaust gas comprising the hydrogen ignites a first fuel type in response to a compression event.

In another embodiment of the present disclosure, an apparatus is provided comprising: an engine comprising at least a first cylinder and a second cylinder, the first cylinder is a dedicated EGR cylinder, the first cylinder utilizes at least one of spark ignition, fuel-fed pre-chamber ignition, laser ignition, corona ignition, or plasma ignition configured to provide an exhaust gas; and the second cylinder is a non-dedicated EGR cylinder utilizing compression ignition.

In another embodiment of the present disclosure, an apparatus is provided comprising an engine comprising at least a first cylinder and a second cylinder; the first cylinder is a dedicated-EGR cylinder utilizing spark ignition and the second cylinder is a gasoline compression ignition cylinder utilizing compression ignition; the first cylinder is configured to combust an air and fuel mixture in response to an occurrence of an ignition spark and provide an exhaust gas comprising a quantity of hydrogen; an exhaust gas recirculation (EGR) circuit configured to provide the exhaust gas from the first cylinder to the second cylinder; and wherein the exhaust gas comprising the hydrogen ignites a fuel type in response to a compression event.

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein:

FIG. 1 is block diagram of an exemplary gasoline compression ignition engine system with dedicated-exhaust gas recirculation according to an embodiment of the present disclosure.

FIG. 2 is a flow diagram depicting an exemplary method of operating the engine system of FIG. 1.

### DETAILED DESCRIPTION OF EMBODIMENTS

The embodiments disclosed herein are not intended to be exhaustive or to limit the disclosure to the precise forms disclosed in the following detailed description. Rather, the embodiments were chosen and described so that others skilled in the art may utilize their teachings.

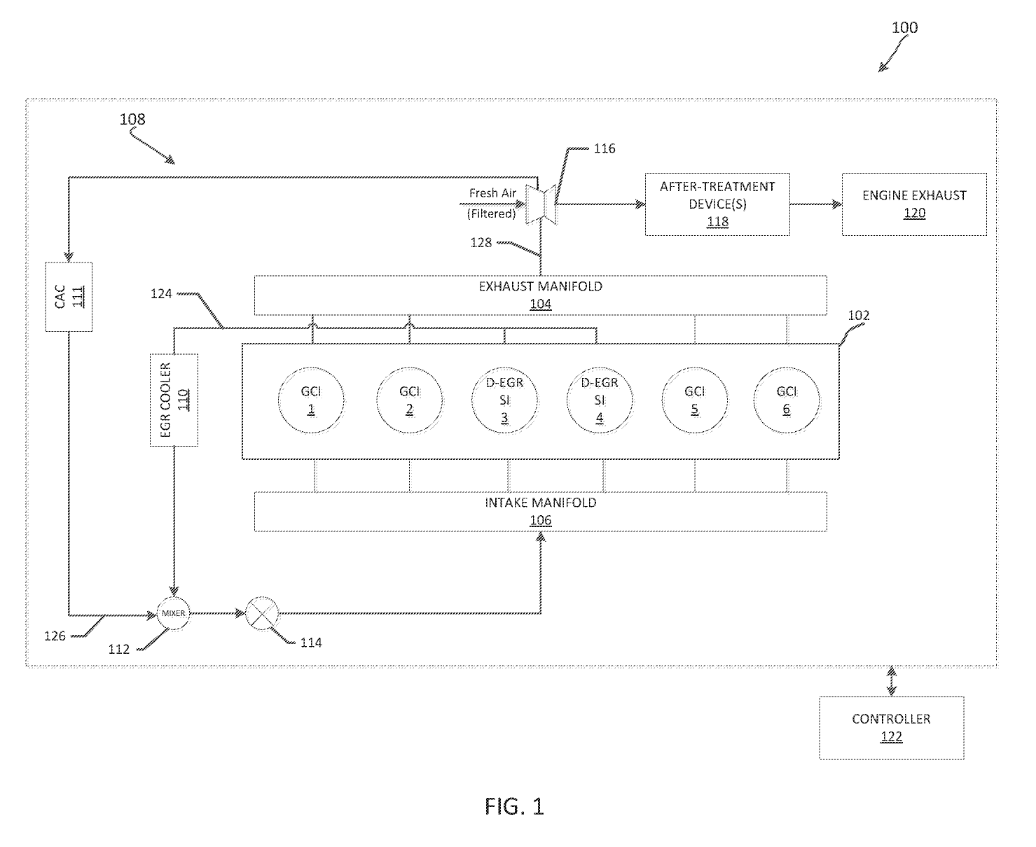

Referring now to FIG. 1, a block diagram of engine system 100 is shown comprising a gasoline compression ignition engine with one or more dedicated-exhaust gas recirculation cylinders according to an embodiment of the present disclosure. The following description is merely exemplary in nature and is in no way intended to limit the disclosure, its application, or uses. As used herein, the phrase at least one of A, B, or C should be construed to mean a logical (A or B or C), using a non-exclusive logical OR. It should be understood that steps within a method may be executed in a different order without altering the principles of the present disclosure. As used herein, the term controller, determiner, or interpreter may refer to an Application Specific Integrated Circuit (“ASIC”), an electronic circuit, a processor (shared, dedicated, or group) and memory that execute one or more software or firmware programs, a combinational logic circuit, and/or other suitable components that provide the described functionality.

As shown in the illustrative embodiment of FIG. 1, engine system 100 generally includes gasoline compression ignition engine 102 (hereinafter “engine 102”), exhaust manifold 104, and intake manifold 106. System 100 further comprises controller 122, after-treatment device 118, engine exhaust 120, and air handling system 108 including exhaust gas recirculation cooler 110, charge air cooler 111, mixing device 112, intake throttle 114, and turbocharger 116. In certain embodiments, engine 102 may be an inline cylinder engine or V-configuration cylinder engine. As described in further detail below, whether engine 102 includes an inline cylinder or V cylinder configuration, one or more of the cylinders of engine 102 may be dedicated-exhaust gas recirculation cylinders (hereinafter “dedicated-EGR”). In the illustrative embodiment of FIG. 1, engine 102 includes an inline 6-cylinder internal combustion engine have two dedicated-EGR cylinders and 4 gasoline compression ignition (hereinafter “GCI”) cylinders. The present disclosure further includes embodiments wherein a 6-cylinder inline or V-configuration engine may have 1 or more dedicated-EGR cylinders or 3 or fewer dedicated-EGR cylinders. Likewise, in such embodiments, the remaining non-dedicated-EGR cylinders may be GCI cylinders. Further, in certain embodiments, engine 102 may be a 4-cylinder engine or an 8-cylinder engine. Further still, in certain embodiments, engine 102 may include fewer than 6 cylinders or, alternatively, engine 102 may include 6 or more cylinders.

The term dedicated-EGR, as utilized herein, should be read broadly. Any EGR arrangement wherein, during at least certain engine operating conditions, some or all of the exhaust output of certain cylinders is recirculated to engine intake manifold 106 is a dedicated-EGR cylinder. In the illustrative embodiment of FIG. 1, system 100 includes cylinder 3 and cylinder 4 as two spark ignited dedicated-EGR cylinders. As shown in FIG. 1, EGR gas 124 recirculates and combines or mixes with intake gas 126 (formerly partially exhaust gas 128) at a position upstream of intake manifold 106. EGR gas 124 may combine with the intake gas 126 at mixer 112 or by any other arrangement. In one embodiment, EGR gas 124 returns directly to intake manifold 106. In another embodiment, EGR gas 124 may combine with compressed and cooled air flowing toward mixer 112 via a high pressure fluid flow path downstream of a compressor 116 and upstream of intake manifold 106. In this embodiment, the high pressure air may be cooled by charge-air-cooler 111. In certain embodiments, system 100 may not include a compressor or any other type of boost pressure generating device. In the embodiment of FIG. 1, system 100 may include EGR cooler 110 and intake throttle 114 in the EGR loop, wherein intake throttle 114 selectively throttles or adjusts the flow rate of the combined EGR and intake gas which exits mixer 112. In an alternative embodiment, the recirculated EGR gas may be routed around, via a by-pass valve, either EGR cooler 110 in the dedicated-EGR loop or charge-air-cooler 111 in the EGR/Filtered fresh air loop. In yet another embodiment, intake throttle 114 may be positioned immediately upstream of charge-air-cooler 111.

In certain embodiments, system 100 may utilize an air handling system architecture comprising a single or multiple turbochargers such as, for example, a wastegate turbo, a variable nozzle turbo, a purely electric turbo, or a variable geometry turbo (“VGT”). In one embodiment, system 100 may utilize a single or multiple superchargers in lieu of a single or multiple turbochargers. In one embodiment, system 100 may include at least one turbo charger and at least one supercharger or at least one turbo of a first type (e.g. VGT) and at least one turbo charger of a second type (e.g. purely electric). Additionally, in certain embodiments, system 100 may utilize an air handling architecture further comprising one or more intake and/or exhaust throttles. Similarly, the air handling architecture may further comprise one or more EGR coolers 110 as well as one or more charge-air-coolers 111. In certain embodiments, a variable-valve actuation (“VVA”) system may be utilized on the dedicated-EGR and/or GCI cylinders. As is generally known in the art, VVA technologies may be used to add flexibility to a valve train of engine 102 by enabling variable valve event timing, duration and/or lift. Exemplary VVA technologies include valve timing control (VTC), variable valve lift (VVL) and camless valve trains.

In various embodiments of the present disclosure, dedicated-EGR cylinders may utilize any combination of the following ignition systems: spark ignition, fuel-fed pre-chamber ignition, passive pre-chamber ignition, laser ignition, corona ignition, or plasma ignition. In one embodiment, exemplary GCI cylinders of system 100 are configured to ignite on compression of a fuel source (e.g. gasoline, ethanol fuel, alcohol based fuel) delivered to the cylinder by an exemplary fuel injection device. In this embodiment, one or more of the dedicated-EGR cylinders may be configured to include an exemplary spark-assist device such as, for example, a glow-plug or other exemplary heating device configured to aid the ignition and combustion process of an internal combustion engine, such as intake air heaters (electric or fuel burner) or spark plugs. In another embodiment, one or more of the GCI cylinders or non-dedicated EGR cylinders may be configured to include an exemplary spark-assist device such as, for example, a glow-plug or other exemplary heating device configured to aid the ignition and combustion process of an internal combustion engine, such as intake air heaters (electric or fuel burner) or spark plugs. In yet another embodiment of the present disclosure, a variable-energy ignition system may be utilized for one or more of the GCI cylinders. Exemplary variable-energy ignition systems configured for use with spark-ignited ignition systems may include the CPU-XL Vari-Spark Ignition System manufactured by Altronic LLC. The functionality provided by the vari-spark ignition system within engine 102 is discussed in further detail hereinbelow.

In certain embodiments, controller 122 forms a portion of a processing subsystem including one or more computing devices having memory, processing, and communication hardware. Controller 122 may be a single device or a distributed device, and the functions of the controller may be performed by hardware and/or as computer instructions on a non-transient computer readable storage medium. Controller 122 generally includes a logic/processor and memory. In one embodiment, the logic/processor of controller 122 is a microprocessor that includes one or more control algorithms or logic that is generally operable to control and manage the overall operation of engine 102 and the plurality of aforementioned sub-systems that comprise system 100. In one embodiment, the processor may include one or more microprocessors, microcontrollers, digital signal processors (“DSPs”), combinations thereof and/or such other devices known to those having ordinary skill in the art that may be configured to process one or more data and/or parameter signals to provide one or more control signals.

In certain embodiments, controller 122 includes one or more interpreters such as for example one or more interface devices configured to receive and interpret data signals and one or more determiners such as, for example, the aforementioned processor that functionally executes the operations of the controller. The description herein including interpreters and determiners emphasizes the structural independence of certain aspects of the controller 122, and illustrates one grouping of operations and responsibilities of the controller. Other groupings that execute similar overall operations are understood within the scope of the present disclosure. Interpreters and determiners may be implemented in hardware and/or as computer instructions on a non-transient computer readable storage medium, and may be distributed across various hardware or computer based components. Example and non-limiting implementation elements that functionally execute the operations of the controller include sensors providing any value determined herein, sensors providing any value that is a precursor to a value determined herein, datalink and/or network hardware including communication chips, oscillating crystals, communication links, cables, twisted pair wiring, coaxial wiring, shielded wiring, transmitters, receivers, and/or transceivers, logic circuits, hard-wired logic circuits, reconfigurable logic circuits in a particular non-transient state configured according to a specification, any actuator including at least an electrical, hydraulic, or pneumatic actuator, a solenoid, an op-amp, analog control elements (springs, filters, integrators, adders, dividers, gain elements), and/or digital control elements.

Controller 122 may include a number of inputs and outputs for interfacing with various sensors and systems coupled to engine 102. In one embodiment, controller 122 may be a known control unit customarily referred to by those of ordinary skill as an electronic or engine control module (“ECM”), electronic or engine control unit (“ECU”) or the like, or may alternatively be a control circuit capable of operation as will be described herein. In one embodiment, the aforementioned memory includes random access memory (“RAM”), dynamic random access memory (“DRAM”), and/or read only memory (“ROM”) or equivalents thereof, that store data and programs that may be executed by the processor and allow controller 122 to communicate with the above-mentioned components to cause system 100 to perform the functionality described herein. In one embodiment, one or more sectors of the memory may include non-volatile memory sectors that are configured to retain data while the memory is in a powered down state. Certain operations described herein include operations to interpret and/or to determine one or more parameters or data structures. Interpreting or determining, as utilized herein, includes receiving values by any method known in the art, including at least receiving values from a datalink or network communication, receiving an electronic signal (e.g. a voltage, frequency, current, or Pulse Width Modulated (“PWM”) signal) indicative of the value, receiving a computer generated parameter indicative of the value, reading the value from a memory location on a non-transient computer readable storage medium, receiving the value as a run-time parameter by any means known in the art, and/or by receiving a value by which the interpreted parameter can be calculated, and/or by referencing a default value that is interpreted to be the parameter value.

As noted briefly above, in certain embodiments, one or more cylinders of engine 102 include a direct injector for fueling. A direct injector, as utilized herein, includes any fuel injection device that injects fuel directly into the cylinder volume, and is capable of delivering fuel into the cylinder volume when the intake valve(s) and exhaust valve(s) are closed. The direct injector may be structured to inject fuel at the top of the cylinder. In certain embodiments, the direct injector may be structured to inject fuel into a combustion pre-chamber, although in certain embodiments the one or more cylinders of engine 102 may not include a combustion pre-chamber. In one embodiment, each dedicated-EGR cylinder may include one or more direct injectors. The direct injectors may be the primary or the only fueling device for the dedicated EGR cylinders, or alternatively the direct injectors may be an auxiliary or secondary fueling device for the dedicated-EGR cylinders.

As is generally known in the art, engine 102 combusts an air/fuel mixture to produce drive torque for a vehicle. As noted above, the present disclosure generally allows for both compression ignition (GCI cylinders) and spark ignition (dedicated-EGR cylinders). The present disclosure therefore provides a unique engine architecture which utilizes dedicated-EGR to aid the performance/feasibility of a gasoline compression engine. As described in further detail below, internal combustion engines configured to supply desired quantities of EGR constituents to one or more exemplary GCI cylinders help mitigate and/or overcome challenges associated with the performance of GCI engines during less than nominal engine loads. GCI engines have the potential to offer performance, torque output, and fuel economy characteristics which are comparable to conventional diesel engines. Moreover, with refinements to existing GCI technology, GCI engines may even displace diesel engine sales in certain automotive markets. Hence, the present disclosure provides a method and apparatus comprising an engine architecture that aids in achieving desired performance parameters during low load combustion of GCI engines.

Referring again to the illustrative embodiment of FIG. 1, engine system 100 generally provides the following functionality. In certain embodiments of the present disclosure, system 100 may be configured to provide for controlled oxygen availability to the one or more GCI cylinders. In one embodiment, system 100 may be configured to adjust the in-cylinder air-fuel-ratio (“AFR”) of the one or more dedicated-EGR cylinders. The in-cylinder AFR (lambda) of the dedicated-EGR cylinders may vary between “rich” (e.g. lambda<1) and “lean” (lambda>1) combustion conditions. In-cylinder AFR is a required control mechanism since fuel combustion characteristics within the GCI cylinders is primarily dependent upon oxygen availability. Hence, system 100 may be configured to supply desired quantities of EGR constituents to one or more exemplary GCI cylinders. In one embodiment, the GCI cylinders consistently operate by utilizing a lean AFR, i.e. lambda>1. In certain embodiments, controller 122 may provide one or more control signals to an exemplary fuel supply system and air handling system 108 to adjust the AFR and achieve the desired air and fuel mixture to generate the desired EGR constituents.

Available torque output within GCI engines is primarily a function of air/oxygen availability, however the presence of other elements such as, for example, hydrogen content in the supplied air fuel mixture may influence the combustion processes in the GCI cylinders. Accordingly, the present disclosure provides for controlling hydrogen availability to the GCI cylinders by adjustment of in-cylinder AFR of the dedicated-EGR cylinders. As noted above, control of the in-cylinder AFR of the one or more dedicated-EGR cylinders is a required control mechanism since the combustion “knock” limit of the GCI cylinders may be improved with additional hydrogen availability. In one embodiment, engine 102 may receive a significantly “rich” AFR in the dedicated-EGR cylinders 3 and 4. The significantly rich AFR will increase the amount of hydrogen supplied to the dedicated GCI cylinders. The increased hydrogen content within the GCI cylinders functions as a combustion catalyst and will substantially mitigate the occurrence of combustion engine “knock” in the GCI cylinders when engine system 100 and engine 102 are operating under low-load engine conditions. As is known in the art, fuel supplied to the cylinder should burn in even waves that are timed to the engine's operating cycles. However, when fuel is improperly or prematurely ignited, it may cause an explosion that may interfere with an engine's operating cycles and may even damage internal engine components. Additionally, these premature detonations are the source of “ping” or “knock” noise within an exemplary engine such as engine 102. Hence, the presence of hydrogen in the GCI-cylinder substantially mitigates premature detonation and provides for controlled flame propagation. In one embodiment, controller 122 may include one or more algorithms that when executed by the processor causes controller 122 to provide control signals to modify or influence the EGR gas profile.

In certain embodiments, system 100 may include direct fuel injectors configured to provide a rich dedicated-EGR cylinder operating environment and injection conditions that provide favorable species for combustion (e.g. highly rich operation producing H2 or CO). In certain additional or alternative embodiments, with regard to controller 122, control signals may be provided that cause retarded fuel injection timing, a stratified injection timing, a predetermined rich fueling amount, and/or a predetermined injection timing (and/or fueling amount) determined to produce a desired amount of one of H2, unburned HC, and CO. In these embodiments, the aforementioned Vari-Spark system may be utilized within system 100 to adjust, for example, the amplitude, duration, timing, energy magnitude and/or power of the spark generated within one or more dedicated-EGR cylinders. Accordingly, in certain embodiments, the Vari-Spark system allows for dedicated-EGR spark profile optimization which further allows for influencing the characteristics of the EGR gas constituents that are mixed with intake gas 126 and received by the one or more GCI cylinders via intake manifold 106.

Compositional components, as well as induced thermal energy, provided by the dedicated EGR cylinders may be provided entirely and immediately to the engine intake manifold 106 for utilization in one or more GCI cylinders. The present disclosure therefore provides for the ability to influence combustion activities within gasoline compression ignition engines operating during low load, low temperature, and/or low compression scenarios in which ignition and combustion of, for example, high octane fuel is difficult to control. As is known by one of ordinary skill in the art, it may be difficult to match fuel octane levels with engine compression ratios to achieve compression ignition characteristics which work for all engine temperature and compression ranges. For example, fuels having a higher octane content typically require higher engine temperature and compression operating conditions. Conversely, fuels having a lower octane content typically require lower engine temperature and compression operating conditions. Hence, it follows that high octane fuel in lower compression engines will necessarily require an additive element to influence the reactivity of the fuel within an exemplary low pressure/low temperature GCI cylinder. Accordingly, the present disclosure allows for the controlled introduction of, for example, predetermined quantities of hydrogen to support ignition of, for example, high octane fuel during low compression operating conditions of GCI engines.

The present disclosure further provides for reformation of the unburned fuel available to the GCI cylinders through adjustment of the fuel injection timing within the dedicated-EGR cylinders. Adjustment of the fuel injection timing is a required control mechanism as the properties of any unburnt fuel will affect combustion within the GCI cylinders. Additionally, fuel injection timing in the GCI cylinders may also be adjusted based on, for example, 1) the amount of oxygen present within the GCI cylinders, 2) the amount of hydrogen present within the EGR gas provided to the GCI cylinders, and/or 3) the unburned fuel properties supplied within the EGR gas from the dedicated-EGR cylinders. In certain embodiments of the present disclosure, a Variable-Valve Actuation (VVA) system may be utilized on the dedicated-EGR cylinders to adjust (reduce) the amount of EGR gas 124 supplied to the GCI cylinders. Use of the VVA allows for EGR fractions at levels below the fixed ratio of dedicated-EGR cylinders. In yet another embodiment, one or more by-pass valves may be utilized in conjunction with EGR cooler 110 and charge-air-cooler 111 to influence oxygen availability, air pressure, and temperature within the GCI cylinders.

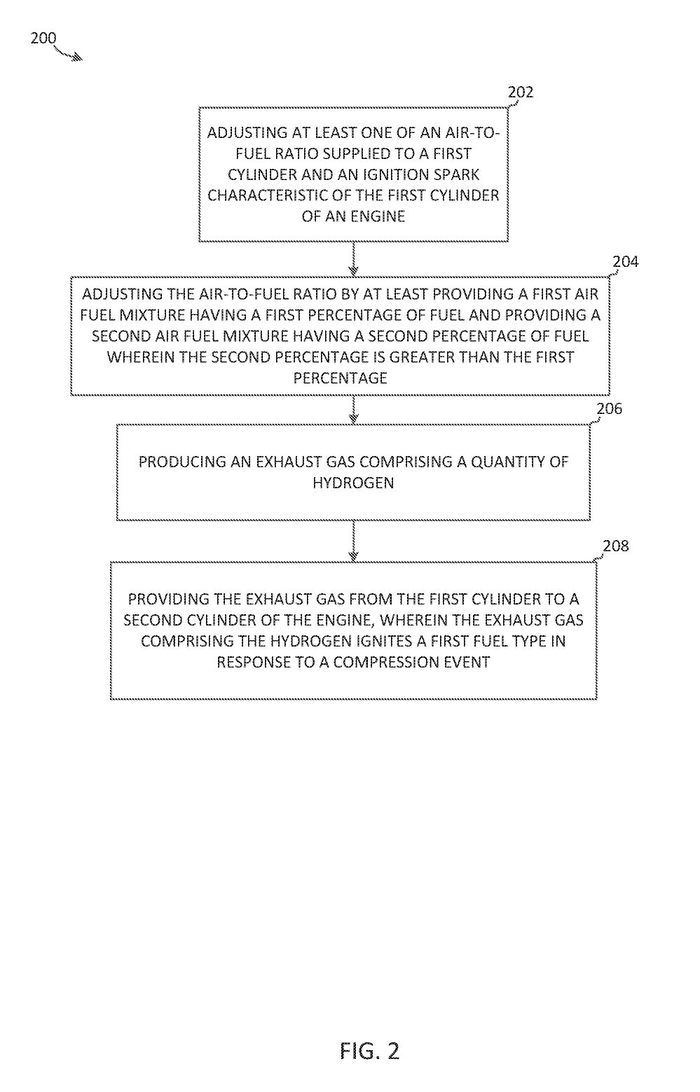

FIG. 2 depicts a flow diagram of an exemplary method 200 of operating gasoline compression ignition engine system 100 according to an embodiment of the present disclosure. In certain embodiments, method 200 may be implemented and/or executed in an exemplary engine system 100. As such, a description of method 200 will reference the aforementioned components and sub-systems of engine system 100. Method 200 begins at decision block 202 by adjusting at least one of an air-to-fuel ratio supplied to a first cylinder or an ignition spark characteristic of the first cylinder of an engine. In the disclosed embodiment of FIG. 2, the first cylinder may be a dedicated-EGR cylinder. At block 204, method 200 adjusts the air-to-fuel ratio of a first exemplary air and fuel mixture by providing at least a first air and fuel mixture having a first percentage of fuel and providing a second air and fuel mixture having a second percentage of fuel. In one embodiment, the second percentage of fuel is greater than the first percentage of fuel. In another embodiment, the air and fuel mixture is adjusted by adding a second percentage of fuel to cause the air-to-fuel ratio to transition from a lean air and fuel mixture to a rich air and fuel mixture. At block 206, method 200 includes producing exhaust gas comprising a quantity of hydrogen. In one embodiment, the quantity of hydrogen is predetermined. Method 200 then proceeds to block 208 and provides the exhaust gas from the first dedicated-EGR cylinder to a second cylinder of the engine. In one embodiment, the second cylinder has a first pressure and the exhaust gas comprising the hydrogen causes ignition of or ignites a first fuel type in response to a compression event occurring when the first pressure is below a threshold. In the disclosed embodiment of FIG. 2, the second cylinder is a gasoline compression ignition cylinder.

In the foregoing specification, specific embodiments of the present disclosure have been described. However, one of ordinary skill in the art will appreciate that various modifications and changes can be made without departing from the scope of the disclosure as set forth in the claims below. Accordingly, the specification and figures are to be regarded in an illustrative rather than a restrictive sense. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued. No claim element herein is to be construed under the provisions of 35 U.S.C. 112(f) unless the element is expressly recited using the phrase “means for.”

1. A method, comprising:
adjusting at least one of an air-to-fuel ratio supplied to a first cylinder and an ignition spark characteristic of the first cylinder of an engine to produce an exhaust gas comprising a quantity of hydrogen; and
providing the exhaust gas from the first cylinder to a second cylinder of the engine, wherein the exhaust gas comprising the hydrogen ignites a first fuel type in response to a compression event.

2. The method of claim 1, wherein the first cylinder is a dedicated-exhaust gas recirculation (EGR) cylinder and the second cylinder is a gasoline compression ignition cylinder (GCI).

3. The method of claim 2, wherein the first cylinder utilizes at least one of spark ignition, fuel-fed pre-chamber ignition, laser ignition, corona ignition, or plasma ignition; and
the second cylinder utilizes compression ignition.

4. The method of claim 3, wherein the first cylinder utilizes spark ignition.

5. The method of claim 1, wherein adjusting the air-to-fuel ratio comprises providing a first air fuel mixture having a first percentage of fuel and providing a second air fuel mixture having a second percentage of fuel wherein the second percentage is greater than the first percentage.

6. The method of claim 1, wherein adjusting the ignition spark characteristic comprises adjusting at least one of a spark amplitude, a spark duration, a spark energy magnitude, or a spark occurrence relative to introduction of an air and fuel mixture to the first cylinder.

7. The method of claim 6, wherein adjusting the spark occurrence relative to the introduction of the air and fuel mixture to the first cylinder comprises providing a first spark at a first time period and providing a second spark at a second time period.

8. An apparatus comprising:
an engine comprising at least a first cylinder and a second cylinder, the first cylinder is a dedicated EGR cylinder, the first cylinder utilizes at least one of spark ignition, fuel-fed pre-chamber ignition, laser ignition, corona ignition, or plasma ignition configured to provide an exhaust gas; and
the second cylinder is a non-dedicated EGR cylinder utilizing compression ignition.

9. The apparatus of claim 8, further comprising an exhaust gas recirculation (EGR) circuit configured to provide the exhaust gas from the first cylinder to the second cylinder; and
wherein the exhaust gas ignites a fuel type in response to a compression event.

10. The apparatus of claim 8, wherein the first cylinder utilizes spark ignition; and
the second cylinder is a gasoline compression ignition engine.

11. The apparatus of claim 8, wherein the first cylinder has an adjustable in cylinder air-fuel ratio such that oxygen availability to the second cylinder is controllable;
wherein a first air fuel mixture having a first percentage of fuel and a second air fuel mixture having a second percentage of fuel wherein the second percentage is greater than the first percentage are provided to the first cylinder.

12. The apparatus of claim 8, wherein the second cylinder further includes a spark assist device configured to aid ignition and combustion process of the engine.

13. The apparatus of claim 12, wherein the spark assist device includes a glow-plug, an electric intake air heater, a fuel burner intake air heater, or spark-plug.

14. The apparatus of claim 8, wherein at least one of the first cylinder or the second cylinder includes a direct injector for fueling.

15. The apparatus of claim 8, wherein each of the first cylinders include one or more direct injectors for fueling.

16. The apparatus of claim 8, wherein the first cylinder includes an ignition spark characteristic that can be adjusted to produce the exhaust gas.

17. The apparatus of claim 16, wherein the ignition spark characteristic includes at least one of spark amplitude, a spark duration, a spark energy magnitude, or a spark occurrence relative to introduction of an air and fuel mixture to the first cylinder.

18. An apparatus comprising:
an engine comprising at least a first cylinder and a second cylinder;
the first cylinder is a dedicated-EGR cylinder utilizing spark ignition and the second cylinder is a gasoline compression ignition cylinder utilizing compression ignition;
the first cylinder is configured to combust an air and fuel mixture in response to an occurrence of an ignition spark and provide an exhaust gas comprising a quantity of hydrogen;
an exhaust gas recirculation (EGR) circuit configured to provide the exhaust gas from the first cylinder to the second cylinder; and
wherein the exhaust gas comprising the hydrogen ignites a fuel type in response to a compression event.

19. The apparatus of claim 18, wherein the first cylinder has an adjustable in cylinder air-fuel ratio such that oxygen availability of the first cylinder is controllable;
wherein a first air fuel mixture having a first percentage of fuel and a second air fuel mixture having a second percentage of fuel wherein the second percentage is greater than the first percentage are provided to the first cylinder.

20. The apparatus of claim 18, wherein at least one of the first cylinder or the second cylinder includes a direct injector for fueling.
